(19) United States
(12) Patent Application Publication
(10) Pub. No.: US 2008/0056648 A1
(43) Pub. Date: Mar. 6, 2008

(54) OPTICAL MODULE AND OPTICAL COMMUNICATION SYSTEM USING THE SAME

(76) Inventor: Yun-Kyung Oh, Seoul (KR)

Correspondence Address: CHA & REITER, LLC, 210 ROUTE 4 EAST STE 103, PARAMUS, NJ, 07652, US

(21) Appl. No.: 11/627,450

(22) Filed: Jan. 26, 2007

(30) Foreign Application Priority Data
Sep. 5, 2006 (KR) 2006-85117

(51) Int. Cl. G02B 6/36

(52) U.S. Cl. 385/93

(57) ABSTRACT

An optical module and an optical communication system using the optical module are disclosed. The optical module includes an optical active device for receiving or generating light, a housing made of a metal material and having the optical active device mounted therein, an optical filter having a conductive transparent electrode through which light is input to or output from, wherein the transparent electrode is grounded by the housing. The optical communication system includes an optical transmission module including light sources, a first housing having the light sources mounted therein, and a first filter having a transparent electrode that is formed in the opening and electrically contacts the first housing, and an optical reception module including optical detectors formed in one-to-one correspondence to the light sources, a second housing having the optical detectors mounted therein and having an opened side on the traveling paths of the lights, and a second filter disposed between the light sources and the optical detectors and having a transparent electrode in a face that faces the optical transmission module.

### CLAIM OF PRIORITY

This application claims priority under 35 U.S.C. § 119 to an application entitled “Optical Module and Optical Communication System Using the Same,” filed in the Korean Intellectual Property Office on Sep. 5, 2006 and assigned Serial No. 2006-85117, the contents of which are incorporated herein by reference.

### BACKGROUND OF THE INVENTION

1. Field of the Invention

The present invention generally relates to an optical communication system, and in particular, to an optical communication system including optical active devices capable of performing Optical-to-Electrical (O/E) conversion and Electrical-to-Optical (E/O) conversion.

2. Description of the Related Art

A general optical communication system typically includes an optical transmission module for generating an optical signal, an optical reception module for receiving the optical signal, and a waveguide medium for transmitting the optical signals between the optical transmission module and the optical reception module. The optical transmission module performs Electrical-to-Optical (E/O) conversion on electrical data to generate an optical signal, and the optical reception module performs Optical-to-Electrical (O/E) conversion on the received optical signal to detect electrical data.

FIG. 1 is a circuit diagram of a conventional optical communication system 100. As shown, the optical communication system 100 includes an optical transmission module 110 for generating an optical signal and an optical reception module 120 for performing O/E conversion on the optical signal. Here, a waveguide or an optical fiber may be used as a medium for transmitting the optical signal.

The optical transmission module 110 includes a light source 111 for converting input electrical data into an optical signal and a driver 112 for controlling the light source 111.

The optical reception module 120 includes an optical detector 121 for performing O/E conversion on the optical signal, an impedance converter 121 for converting the impedance of electrical data detected by the optical detector 121, and a limiting amplifier 122.

The optical transmission module 110 and the optical reception module 120 may be mounted in a cap-shaped metal housing having an opening, which allows light to be incident to or to travel on a path to optical active devices, such as the light source 111 and the optical detector 121.

However, the optical communication system may cause an optical signal to be distorted due to electromagnetic waves that are generated during O/E or E/O conversion process with respect to the optical signal or are introduced from the outside. As a result, detected data may contain noise or cause malfunction of both the optical transmission module and/or the optical reception module.

### SUMMARY OF THE INVENTION

The present invention provides an optical module capable of shielding electromagnetic waves and performing transmission and reception functions, and an optical communication system using the inventive optical module.

In one embodiment, there is provided an optical module, which includes an optical active device for receiving or generating light, a housing made of a metal material and having the optical active device mounted therein, an optical filter having a conductive transparent electrode through which light is input to or output from, wherein the transparent electrode is grounded by the housing.

In another embodiment, there is provided an optical communication system, which includes an optical transmission module having at least two light sources, a first housing having the light sources mounted therein and having an opening on the traveling paths of lights generated from the light sources, and a first filter having a transparent electrode that is formed in the opening and electrically contacts the first housing. The optical transmission module further includes optical detectors formed in one-to-one correspondence to the light sources, a second housing having the optical detectors mounted therein and having an opened side on the traveling paths of the lights, and a second filter disposed between the light sources and the optical detectors and having a transparent electrode that faces the optical transmission module.

### BRIEF DESCRIPTION OF THE DRAWINGS

The above features and advantages of the present invention will become more apparent from the following detailed description when taken in conjunction with the accompanying drawings in which:

FIG. 1 is a circuit diagram of a conventional optical communication system;

FIG. 2 illustrates the structure of an optical module according to a first exemplary embodiment of the present invention;

FIG. 3 illustrates an optical communication system according to a second exemplary embodiment of the present invention;

FIG. 4 illustrates an optical transmission module illustrated in FIG. 3; and

FIG. 5 illustrates an optical reception module illustrated in FIG. 3.

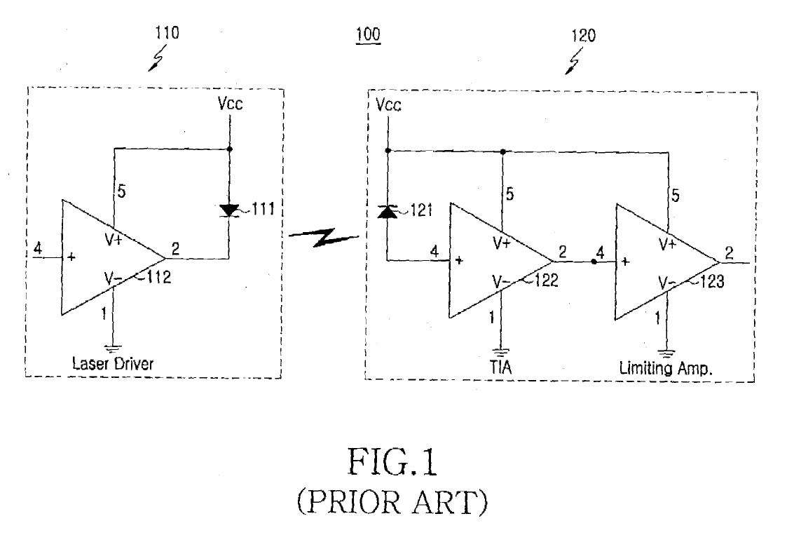

### DETAILED DESCRIPTION OF THE EXEMPLARY EMBODIMENTS

Herein after, exemplary embodiments of the present invention will now be described in detail with reference to the annexed drawings. For the purposes of clarity and simplicity, a detailed description of known functions and configurations incorporated herein has been omitted for conciseness.

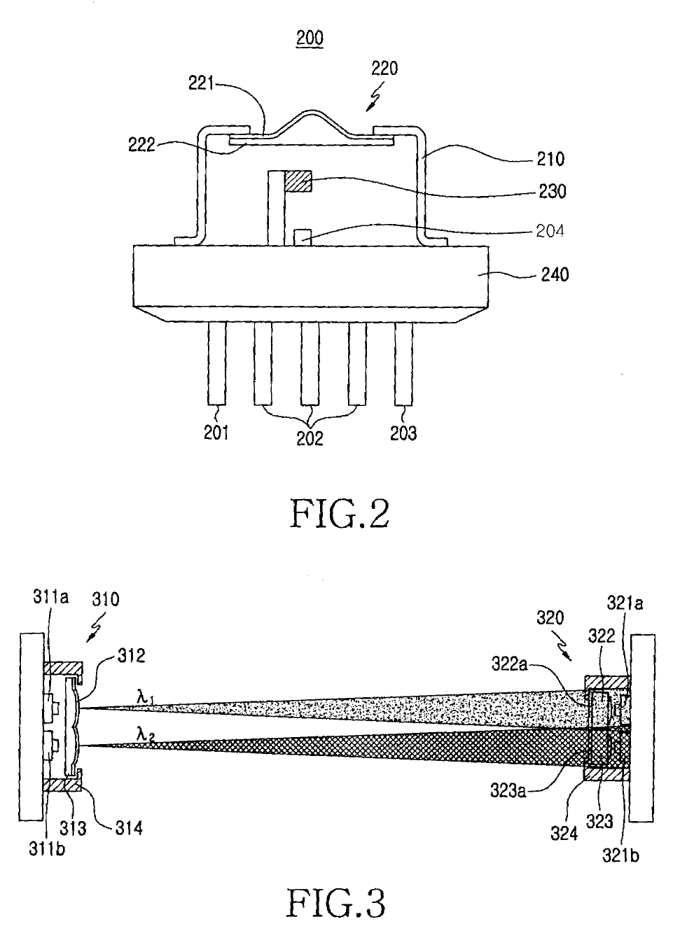

FIG. 2 illustrates the structure of an optical module 200 according to a first exemplary embodiment of the present invention. As shown, the optical module 200 includes an optical active device 230, a metal housing 210 housing an optical active device 230 mounted therein, an optical filter 220 having a conductive transparent electrode 221, which is disposed along a light traveling path, a stem 240 on which the optical active device 230 and the housing 210 are placed, a ground lead 201, and signal and power leads 202 and 203 connected to the optical active device 230.

The optical active device 230 is placed on the stem 240 and is mounted inside the housing 210. A light source capable of generating light having a predetermined wavelength or an optical detector capable of detecting light may be used as the optical active device 230. The housing 210 is made of a metal material and has the shape of a cap in which an opening is formed along the light traveling path. The housing 210 is electrically connected with the ground lead 201.

A monitoring device 204 for monitoring the optical active device 230 may be further disposed between the stem 240 and the optical active device 230.

The optical filter 220 includes a micro lens 222 formed to have curvature on its one face and the transparent electrode 221 that electrically contacts the housing 210. The transparent electrode 221 is made of a conductive transparent material in order to ground the unnecessary electromagnetic wave components through the housing 201 and to transmit light.

The ground lead 201 and the signal and power leads 202 and 203 penetrate the stem 240. The ground lead 201 is electrically connected with the housing 210 in order to maintain the electrically grounded state of the housing 210. The signal and power leads 202 and 203 provide signal input/output and power supply to the optical active device 230.

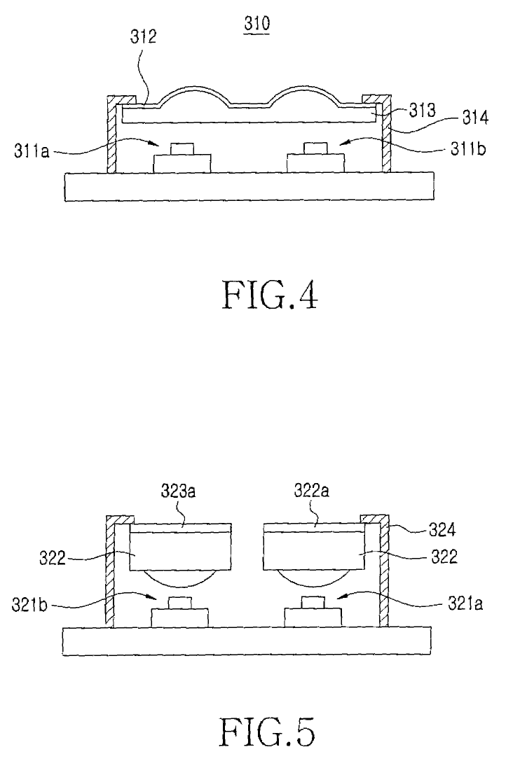

FIG. 3 illustrates an optical communication system 300 according to a second exemplary embodiment of the present invention, FIG. 4 illustrates an optical transmission module 310 illustrated in FIG. 3, and FIG. 5 illustrates an optical reception module 320 illustrated in FIG. 3. As shown, the optical communication system 300 according to the second embodiment includes the optical transmission module 310 for generating lights with different wavelengths and the optical reception module 320 for receiving light generated by the optical transmission module 310.

Referring to FIG. 4, the optical transmission module 310 includes light sources 311a and 311b, a first housing 314, and first filters 312 and 313. The first housing 314 is made of a metal material and has an opening along the traveling paths of lights generated from the light sources 311a and 311b.

The first filters 312 and 313 are positioned in the opening of the first housing 314 and may include the transparent electrode 312 formed in a face that contacts the first housing 314 and the micro lens 313 that faces the light sources 311a and 311b. The transparent electrode 312 transmits light while being electrically grounded by the first housing 314 and grounds unnecessary electromagnetic waves through the first housing 314.

Referring to FIGS. 3 and 5, the optical reception module 320 is positioned at the other side of the optical transmission module 310 and includes optical detectors 321a and 321b corresponding to the light sources 311a and 311b, a second housing 324, and second filters 323, 323a, 322, and 322a.

Photo diodes may be used for the optical detectors 321a and 321b, and the optical detectors 321a and 321b can detect lights generated from the light sources 311a and 311b. The second housing 324 has the same shape as the first housing 314 and has an opening in a face disposed on the traveling paths of lights generated from the light sources 311a and 311b.

The second filters 323, 323a, 322, and 322a are positioned between the light sources 311a and 311b and the optical detectors 321a and 321b, and may include the transparent electrodes 322a and 323a formed in a face that faces the optical detectors 321a and 321b and the micro lens 322 and 323 that face the optical detectors 321a and 321b.

The transparent electrodes 312, 322a, and 323a may be formed by performing vacuum deposition on a dielectric material having conductivity, such as ITO or ZnO, or alternatively depositing dielectric materials to form the multiple layers. The transparent electrodes 312, 322a, and 323a are electrically grounded by the first housing 314 and the second housing 324, thereby preventing unnecessary electromagnetic waves included in input or output lights from causing malfunction and/or noise of the light sources 311a and 311b and the optical detectors 321a and 321b.

As described above, according to the present invention, by blocking noise such as electromagnetic waves from light that is incident to an optical active device using a conductive transparent electrode, malfunction and/or noise generation at the optical active device can be minimized.

While the invention has been shown and described with reference to exemplary embodiments thereof, it will be understood by those skilled in the art that various changes in form and details may be made therein without departing from the spirit and scope of the invention.

What is claimed is:

1. An optical module comprising:
an optical active device for receiving or generating light;
a housing made of a metal material and having the optical active device mounted therein; and
an optical filter having a conductive transparent electrode through which light is input to or output from, wherein the transparent electrode is grounded by the housing.

2. The optical module of claim 1, wherein the optical active device comprises a light source capable of generating light having a predetermined wavelength.

3. The optical module of claim 1, wherein the optical active device comprises an optical detector capable of detecting light.

4. The optical module of claim 1, further comprising:
a stem in which the optical active device and the housing are placed;
a ground lead providing an electrical grounding to the housing; and
a signal lead and a power supply lead coupled to the optical active device.

5. The optical module of claim 1, wherein the housing is made of a conductive metal material.

6. The optical module of claim 1, further comprising a monitoring device for mounting the optical active device.

7. The optical module of claim 1, wherein the optical filter comprises a micro lens having a curvature and a transparent electrode that electrically contacts the housing.

8. An optical communication system comprising:
an optical transmission module including at least two light sources, a first housing having the light sources mounted therein and having an opening along the traveling paths of lights generated from the light sources, and a first filter having a transparent electrode that is formed in the opening and electrically contacts the first housing; and
an optical reception module including optical detectors formed in one-to-one correspondence to the light sources, a second housing having the optical detectors mounted therein and having an opened side along the traveling paths of the lights, and a second filter disposed between the light sources and the optical detectors and having a transparent electrode in a direction that faces the optical transmission module.

9. The optical communication system of claim 8, wherein the first filter further comprises micro lenses formed in one-to-one correspondence to the light sources.

10. The optical communication system of claim 3, wherein the second filter further comprises micro lenses formed in a direction that face the optical detectors in such a way to be in one-to-one correspondence to the light sources.

11. The optical communication system of claim 8, wherein the first filter is disposed along the traveling paths of lights between the light sources and the optical reception module.

12. The optical communication system of claim 8, wherein the transparent electrode is disposed in a direction that faces the optical reception module and is electrically grounded by the first housing.

13. The optical communication system of claim 8, wherein the second filter is disposed along the traveling paths of lights between the optical detectors and the optical transmission module.

14. The optical communication system of claim 8, wherein the transparent electrode is disposed in a direction that faces the optical reception module and is electrically grounded by the second housing.

15. The optical communication system of claim 8, wherein the transparent electrode is formed by depositing ITO or ZnO, or alternatively depositing ITO and ZnO to form multiple layers.
